(19) United States
(12) Patent Application Publication
(10) Pub. No.: US 2021/0078854 A1
(43) Pub. Date: Mar. 18, 2021

(54) HARNESS SADDLE FOR HORSES

(71) Applicant: Tomi WAHLSTEN, Lahti (FI)

(72) Inventor: Tomi WAHLSTEN, Lahti (FI)

(21) Appl. No.: 17/049,424

(22) PCT Filed: Apr. 26, 2019
(86) PCT No.: PCT/FI2019/050337

§ 371 Date: Oct. 21, 2020

(30) Foreign Application Priority Data
Apr. 30, 2018 (FI) 20187061

(51) Int. Cl. B68B 3/00; B68C 1/02

(52) U.S. Cl. CPC B68B 3/00; B68C 1/02

(57) ABSTRACT

Disclosed is a horse harness saddle for pulling a cart. The harness saddle included portion which arches towards both sides of the horse and towards horse's tail so that the harness saddle bypasses the horse's withers, at the back thereof when the harness saddle is worn by the horse. Also disclosed is a method for releasing pressure of pressure towards horse's withers, wherein the horse is harnesses to the cart by the disclosed harness.

### FIELD OF THE INVENTION

This invention relates to a novel harness saddle for reducing the discomfort or pain experienced by the horse at the withers when pulling various carts.

### PRIOR ART

The withers of a horse are an area which easily develops sores and muscle tension due to pressure from the harness. Besides, the harness saddle transmits the forces originating from the carriage, via the shafts, to the horse, causing soreness of the horse's back.

A harness saddle is a part of a horse harness. Its shape is closest to a broad band passing over the horse's back. If often comprises pads and two rein terrets through which the reins run. Under the chest, the harness saddle is fastened by a so-called tight belly girth. The harness saddle serves for two purposes: in very light driving (such as racing), the shafts can be directly fastened to the harness saddle, the pulling by the horse thus being transmitted through the harness saddle; in heavier driving, the shafts are fastened to collar hames but run through the harness saddle, the harness saddle thus preventing the shafts from moving in a disturbing manner.

The various equipment worn by horses, such as the harness saddle, often causes discomfort and even pain to the horse if it is not properly fitted to the horse. Because each horse is an individual, industrially manufactured harness saddles rarely are a perfect fit for the horse. This causes discomfort and pain to the horse, making the horse sore or incapable of optimum performance in harness racing, for example. If the horse's withers become sore, an equine massage therapist is often called for help, for example. Since this kind of therapy is expensive, a badly fitted harness saddle not only causes pain to the horse but also expenses to the owner.

FIG. 1 is a top view a prior-art harness saddle 100, seen in the (−) y-direction of a coordinate system 199. The harness saddle has a first side 101a and a second side 101b. When this harness saddle is worn by a horse, the first side and the second side face the horse's head and the horse's tail, respectively. Both the first side and the second side are substantially parallel, and when the harness saddle is worn by a horse, these sides are perpendicular to the sides 102a, 102b as well as the spine of the horse. The harness saddle 100 is symmetrical with respect to section lines A-A and B-B.

When the harness saddle shown in FIG. 1 is worn by a horse, the first side of the harness saddle may exert pressure on the horse's withers. This often causes soreness of the withers. The best solution to this problem is to make a harness saddle that is good fit for the horse and does not cause pain at its withers but, nevertheless, transmits, via the harness, all of the horse's pulling force to the carriage or cart.

A number of attempts have been made to solve this problem, such as by manufacturing harness saddles designed to leave air space between the horse's spine and the harness saddle. Another way of solving this problem is to attach, on both sides of the horse's withers, parts made of leather or wood, and to support the harness saddle against these parts.

The above-mentioned solutions may have partly solved the problem of sore horse withers. However, these solutions have not fully overcome the problem, i.e. how not to cause pain or discomfort to a horse's withers and to, at the same time, maximally transmit the horse's pulling force, by means of the shafts and straps, to the cart pulled by the horse.

Therefore, there still exists a need to design improved harness saddles fitted for horses.

### BRIEF DESCRIPTION OF THE DRAWINGS

FIG. 1 shows a prior-art harness saddle worn by a horse,

FIG. 2 is a top view of a harness saddle according to a non-limiting example of the invention, worn by a horse,

FIG. 3 is a front view of a harness saddle according to a non-limiting example of the invention, worn by a horse,

FIGS. 4A to C are a top, lateral and front view of a harness saddle according to a non-limiting example of the invention, respectively, and

FIG. 5A to C are a top, lateral and front view of a harness saddle according to a non-limiting example of the invention, respectively.

### SUMMARY

To solve the above-mentioned problems, a novel harness saddle for horses has been developed for more effective pulling of carts and carriages as well as for preventing the horse's withers from becoming sore or for not causing unnecessary muscle tension in the horse.

Thus, the invention relates to a horse harness saddle for pulling carts, the harness saddle comprising a portion adapted to arch from center part of the of the harness saddle towards both sides of the horse and towards the horse's tail, so that the harness saddle bypasses the horse's withers, at the back thereof, when the harness saddle is worn by the horse.

The invention also relates to a method of reducing the pressure on a horse's withers in harness racing, the method comprising harnessing the horse to a cart by means of a harness saddle according to the invention.

### DESCRIPTION OF THE INVENTION

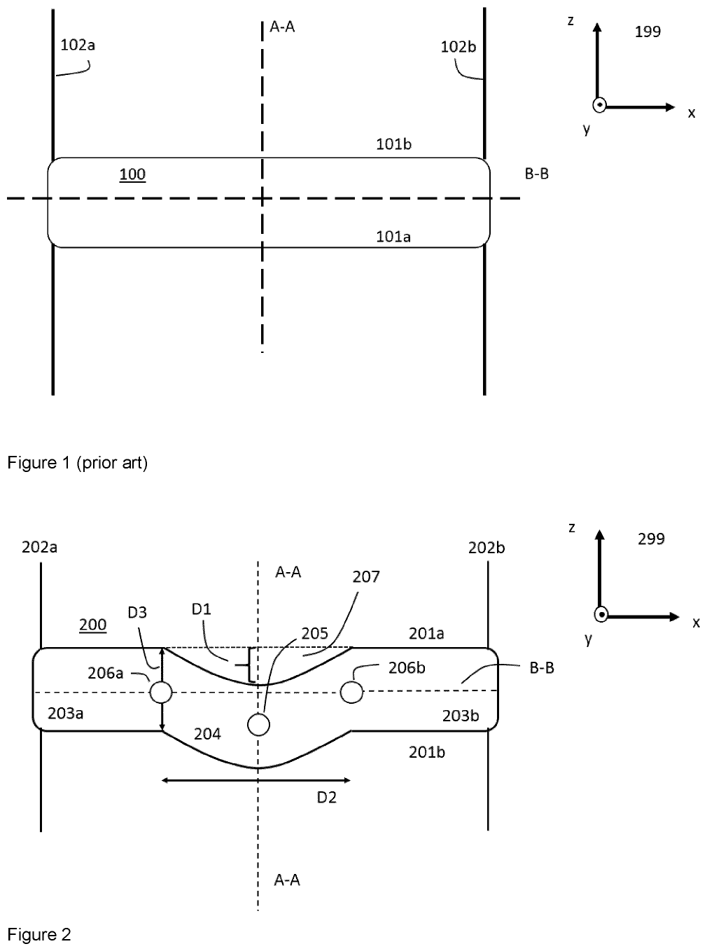

FIG. 1 has been explained in the prior-art chapter of this document.

FIG. 2 shows a harness saddle according to a non-limiting exemplary embodiment of the invention. The figure shows a situation where the harness saddle according to the invention is worn by a horse. In the figure, the harness saddle 200 is seen from above, i.e., in the (−) y-direction of a coordinate system 299. The horse's sides are referred to by 202a and 202b.

The harness saddle comprises a first side 201a, a second side 201b, a first portion 203a, a second portion 203b, and a portion 204 therebetween, i.e. a rear bypass area. The first side and the second side face the horse's head and the horse's tail, respectively and the portion 204 arches from the center part of the harness saddle towards both sides of the horse and towards horse's tail, i.e. in (−) z-direction of the coordinate system 299 so that the harness saddle bypasses the horse's withers 207 from back thereof. Correspondingly, the first portion 203a and the second portion 203b arch along the horse's sides downwards i.e. in (−) y-direction of the coordinate system 299.

Typically, a center hole 205 is provided in the center of the harness saddle, and preferably, holes 206a and 206b are also provided for fastening means, such as screws. The harness saddle is typically symmetric with respect to section line A-A crossing the center hole and asymmetric in respect to section line B-B crossing the holes 206a and 206b.

The portion 204, i.e. the rear bypass area arches towards horse's tail. The arch D1 in the (−)-z direction of the coordinate system 299 is preferably 20-60 mm when measured at the center line of the harness saddle, i.e. at the position where the section line A-A-crosses the center hole. The length D2 of the rear bypass area is for example the same as the distance between the holes 206a and 206b. The width D3 of the harness saddle is typically 5-15 cm. The width of the harness saddle at the position of the center hole is typically 55 mm.

Thus, the harness saddle according to the invention is asymmetrical in respect to the section line B-B so as to conform to the natural shape of the withers of a horse. The harness saddle is designed to be curved, in an arched manner, backwards from the center portion of the harness saddle, towards the horse's tail, thus bypassing the wither area 207 extending upwards from the horse's back, towards the neck and up to the mane, in the front portion of the spine. This leaves more space for the horse's withers and prevents the horse's withers from becoming sore, while providing, at the same time, optimum support for fastening the harness to the harness saddle and for transmitting the pulling force of the horse to the cart or carriage.

According to an embodiment the rear bypass area, seen from above and compared to the prior art, is in the range of 30 to 40 mm, from the center line of the harness saddle. The rear bypass area extends in both directions, from the center of the harness saddle to the screw holes positioned at an identical distance, which is 12 cm, for example, from the center hole. Therefore, in this example, the total length of the bypass area, which is arched backwards, is approximately 24 cm.

Now that this area of a horse's withers which develops sores can be bypassed further back, there is practically no pressure on the withers. All of the previously known products have directly passed over the withers, causing back problems. The difference from the past is most visible in a top view of the harness saddle because the previously known designs have always been straight and symmetrical when seen from above, but the harness saddle according to the invention is asymmetrical, being curved backwards from the center thereof. An offset of just a few centimeters backwards may contribute to relieving the pressure on the spine because, on the back of a horse, the ridged mane of the withers is followed, right behind the withers, by an evenly round shape. Therefore, this novel harness saddle reduces the pain or discomfort experienced by the horse but still provides maximum pulling of the cart.

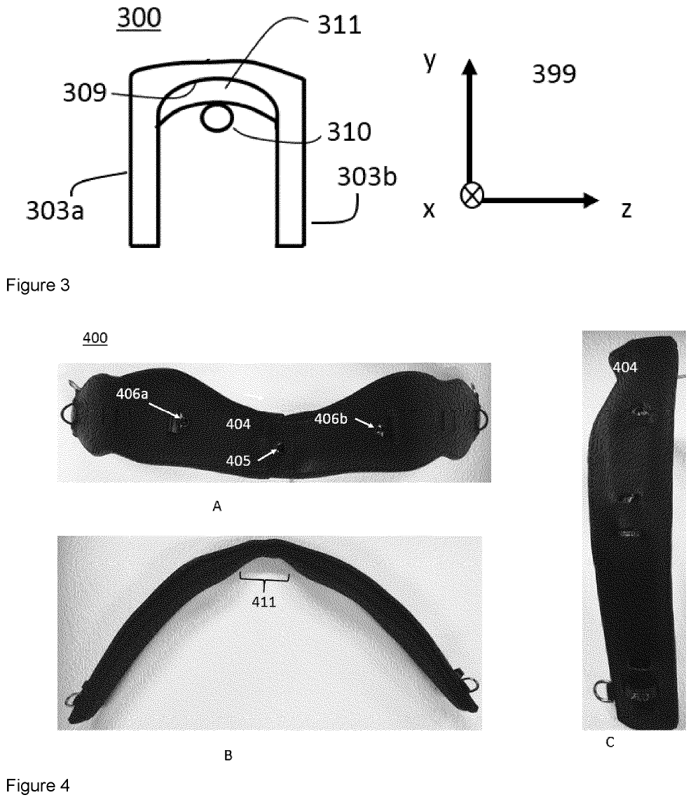

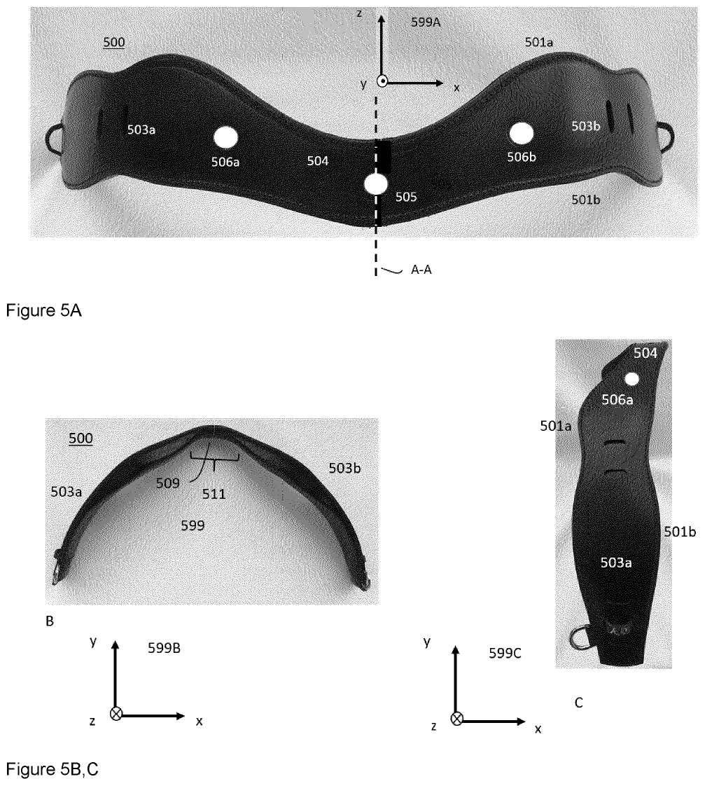

FIG. 3 shows a front view, i.e. as seen in the x-direction of a coordinate system 399 a harness saddle according to an exemplary embodiment of the invention. The figure shows the portions 303a and 303b descending downwards along horse's sides. The harness saddle shown in this figure is designed to leave air space between the portion 309, i.e. the portion of the harness saddle which is towards horse's back, and the horse's spine 310. The portion of the lower face of the harness saddle which enables this is a lower bypass area 311. The lower bypass area of the harness saddle according to the invention can best be seen in FIGS. 4B and 5B.

The material of the harness saddle which comes into contact with the horse may consist of a synthetic material, such as nylon, or a non-synthetic material, such as leather, providing a soft contact against the horse's skin. Typically, a skeleton is provided inside the harness saddle, to provide shape and necessary rigidity to the harness saddle. Typically, the skeleton is made of steel but, instead of steel, it can be made of some other material, such as carbon fibers.

The harness saddle may vary in size, depending on the body structure of the horse. Typically, the width of the harness saddle is 5 cm to 15 cm. The width of the harness saddles at the center hole are typically 55 mm. The length of the harness saddle is approximately 100 cm, bending over the horse's back, along both two sides of the horse. Further, shorter harness saddles with the same proportions are manufactured for smaller horse breeds and ponies.

On the back of a horse, the harness saddle serves to attach a cart pulled by the horse, at cart shafts, to the horse, when driving the horse. The harness saddle sits on the back of the horse by means of specific fastening straps. There are two principal ways of attaching the cart to the harness saddle. One of them is the shaft loop harness, having two subdivisions—a so-called standard shaft loop harness/conventional model and loop thru model with a binding strap, instead of a loop, tied around the shaft.

The other way of attaching the cart to the harness saddle is the Quick Hitch harness, with integrated shaft fittings fastened to the harness or the harness saddle, or to harness saddle locking devices, in a spring-loaded manner.

All of the above-described methods of attachment represent internationally known standards, and the novel harness saddle presented herein can be fastened to a carriage pulled by a horse by employing any of the above-described methods of attachment.

FIGS. 4 and 5 are a front, lateral and top view of the harness saddles according to the invention.

FIG. 4A is a top view of the harness saddle 400 according to invention. The rear bypass area 404 of the harness saddle, seen from above and compared to the prior art, is approximately 20 to 60 mm from the center line of the harness saddle. The rear bypass area extends, on both sides, from the center of the harness saddle, in both directions, to the screw holes 406a, 406b, positioned at an identical distance, which is 12 cm, for example, from the center hole 405. Therefore, the total length of the bypass area, which is arched backwards, is approximately 24 cm, thus leaving the horse's withers practically pressure-free.

FIG. 4B is a front view of the harness saddle 400. The figure shows the lower bypass area 411 of the harness saddle where the harness saddle is designed to leave air space between the horse's spine and the harness saddle. The lower bypass area is located at the center hole 405 of the harness saddle.

FIG. 4C is a lateral view of the harness saddle 400. The figure shows the rear bypass area 404.

FIGS. 5A to C show a harness saddle according to another embodiment. In FIG. 5A the harness saddle is show from above, i.e. in (−) y-direction of the coordinate system 599A. The harness saddle comprises a first side 501a, a second side 501b, portions 503a and 503b descending along sides of the horse, and a portion 504 therebetween, i.e. the rear bypass area. The first side of the harness saddle and the second side of the harness saddle is towards horse's head and the second side is towards horse's tail, respectively, when the harness saddle is worn by the horse. There is a hole 505 in the center part of the harness saddle and in the same distance from the hole 505 there are holes 506a and 506b for fastening means such as screws. The harness saddle 500 is symmetrical in respect to the section line A-A in z-direction of the coordinate system 599 crossing the central hole.

FIG. 5B is the front view of the harness saddle 500, i.e. seen in z-direction of the coordinate system 599B. The figure shows the portions 503a and 503b descending downwards the sides of the horse. The harness saddle has been designed so that there is airspace between the portion 509 i.e. the portion facing horse's back and the horse's spine. The lower surface of the harness saddle which enables this is a lower bypass area 511.

FIG. 5C is the lateral view of the harness saddle 500, i.e. seen in z-direction of the coordinate system 599C. The figure shows the first portion 503a descending downwards the horse's side, the sides of the harness saddle 501a and 501b, the portion 504, i.e. the rear bypass area and the first hole 506a for the fastening means.

The invention also relates to a method of reducing the pressure on the withers of a horse in harness racing. In this method, the horse is harnessed to a cart by means of a harness saddle according to the invention.

In the following embodiments of the invention will be set forth in numbered clauses.
1. A Harness saddle (400) for a horse, characterized in that the harness saddle (400) comprises a rear bypass area (404) extending, in an arched manner, towards both sides of the horse and bypassing an area of the horse's withers, prone to becoming sore, at the back thereof, thus reducing the pressure on the horse's withers.
2. The harness saddle as defined in clause 1, characterized in that it also comprises a lower bypass area (411) leaving air space between the horse's spine and the harness saddle.
3. The harness saddle as defined in clause 1, characterized in that the rear bypass area of the harness saddle, seen from above, is 30 to 40 mm from the center line of the harness saddle, and extends from the center of the harness saddle, in both directions, around the horse, over a distance of approximately 12 cm.
4. A method of reducing pressure on the back of a horse, at its withers, in harness racing, characterized in that a harness saddle (400) comprising a rear bypass area (404), extending, with an identical arch on both sides of the horse, and bypassing an area of the horse's withers, prone to becoming sore, at the back thereof, thus reducing the pressure on the horse's withers.
5. The method as defined in clause 4, characterized in that the harness saddle (400) used for attaching the horse to the cart also comprises a lower bypass area (411) leaving air space between the horse's spine and the harness saddle.
6. The method as defined in clause 4, characterized in that, in a top view, the rear bypass area of the harness saddle used for attaching the horse to the cart is approximately 30 to 40 mm from the center line of the harness saddle and extends from the center of the harness saddle, in both directions, around the horse, over a distance of approximately 12 cm.

It will be appreciated by a person skilled in the art that the invention is not limited to the above-described exemplary embodiments but may vary within the scope of the accompanying claims. It will also be obvious to the person skilled in the art that the harness saddle can be made of other materials than those mentioned in this application. It will also be obvious to the person skilled in the art that, by changing the dimensions, an equivalent invention can be developed for a horse with an unusual anatomy, for example.

1. A harness saddle for horse for pulling a cart comprising a first side and a second side wherein both the first side and the second side are outer sides of the harness saddle wherein the harness saddle comprises an area adapted to arch from center part of the of the harness saddle towards both sides of the horse and towards the horse's tail, so that the harness saddle bypasses the horse's withers at the back thereof, when the harness saddle is worn by a horse.

2. The harness saddle according to claim 1, further comprising a first portion adapted arch along a first side of the horse and a second portion adapted to arch along a second side of the horse, and wherein the area adapted to arch from center part of the of the harness saddle towards both sides of the horse and towards the horse's tail is therebetween.

3. The harness saddle according to claim 1, further comprising a center hole, a first hole for a fastening means and a second hole for a fastening means.

4. The harness saddle according to claim 3 wherein the holes are equidistant from the center hole.

5. The harness saddle according to claim 2, wherein length D2 of the area adapted to arch from center part of the of the harness saddle towards both sides of the horse and towards the horse's tail is equal to the distance of the first hole and the second hole.

6. The harness saddle according to claim 3, wherein arch D1 of the area adapted to arch from center part of the of the harness saddle towards both sides of the horse and towards the horse's tail as measured at the central hole in is 20-60 mm.

7. The harness saddle according to claim 1, wherein the harness saddle is designed to leave air space between lower face of the harness saddle and the horse's spine.

8. A method of reducing pressure on withers of a horse in harness racing, comprising harnessing the horse to a cart by the harness saddle according to claim 1.

9. The harness saddle according to claim 2, further comprising a center hole, a first hole for a fastening means and a second hole for a fastening means.

10. The harness saddle according to claim 3, wherein length D2 of the area adapted to arch from center part of the of the harness saddle towards both sides of the horse and towards the horse's tail is equal to the distance of the first hole and the second hole.

11. The harness saddle according to claim 4, wherein length D2 of the area adapted to arch from center part of the of the harness saddle towards both sides of the horse and towards the horse's tail is equal to the distance of the first hole and the second hole.

12. The harness saddle according to claim 9, wherein length D2 of the area adapted to arch from center part of the of the harness saddle towards both sides of the horse and towards the horse's tail is equal to the distance of the first hole and the second hole.

13. The harness saddle according to claim 2, wherein the harness saddle is designed to leave air space between lower face of the harness saddle and the horse's spine.

14. The harness saddle according to claim 3, wherein the harness saddle is designed to leave air space between lower face of the harness saddle and the horse's spine.

15. The harness saddle according to claim 4, wherein the harness saddle is designed to leave air space between lower face of the harness saddle and the horse's spine.

16. The harness saddle according to claim 5, wherein the harness saddle is designed to leave air space between lower face of the harness saddle and the horse's spine.

17. The harness saddle according to claim 6, wherein the harness saddle is designed to leave air space between lower face of the harness saddle and the horse's spine.

18. The harness saddle according to claim 9, wherein the harness saddle is designed to leave air space between lower face of the harness saddle and the horse's spine.

19. The harness saddle according to claim 10, wherein the harness saddle is designed to leave air space between lower face of the harness saddle and the horse's spine.

20. The harness saddle according to claim 11, wherein the harness saddle is designed to leave air space between lower face of the harness saddle and the horse's spine.
